(19) United States
(12) Patent Application Publication
(10) Pub. No.: US 2010/0064903 A1
(43) Pub. Date: Mar. 18, 2010

(54) Shrimp basket

(76) Inventor: Benjamin A. Spence, Freeport, FL (US)

Correspondence Address: BENJAMIN A. SPENCE, 1300 BAY GROVE ROAD, FREEPORT, FL, 32439, US

(21) Appl. No.: 12/283,590

(22) Filed: Sep. 12, 2008

(51) Int. Cl. A47J 37/00

(52) U.S. Cl. 99/415

(57) ABSTRACT

An apparatus for steaming shrimp, comprised of a plurality of air permeable shallow containers stacked on a central stand. The central stand has a number of legs which operate to support the apparatus and keep the containers from being immersed in water. By allowing for air permeable containers to stack around a central stand the user can efficiently steam a large number of shrimp or food items at once.

### CROSS-REFERENCES TO RELATED APPLICATIONS

Not Applicable

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of devices made for steaming food. More specifically, the invention comprises a series of stackable air permeable containers that allow shrimp to be cooked quickly and efficiently.

2. Description of the Related Art

Steaming apparatuses are common devices which allow different types of food to cook by way of steam as opposed to immersion in boiling water. A common way to cook shrimp is to steam or boil it. A shrimp pot is a tall and skinny boiling pot. When shrimp is steamed it is typically put in one large air permeable container that sits above the water line in the shrimp pot. However, when shrimp is placed in one large container the shrimp are bunched closely together, limiting the steam's access to the full surface area of each individual shrimp. The limited steam access extends the cooking time and may cause uneven cooking.

Therefore what is needed is a container that allows each surface of each shrimp to be fully exposed to the steam while still allowing a large number of shrimp to be cooked at once.

### BRIEF SUMMARY OF THE INVENTION

The present invention comprises an apparatus for steaming food, preferably shrimp, that allows a large amount of surface area of the food to be exposed to the steam. In the preferred embodiment, a plurality of air permeable, shallow containers are stacked around a central stand. The central stand has a number of legs which operate to keep the containers from being immersed in the boiling water and also support the apparatus. Additionally, the apparatus contains a lift hook that can be used to move the apparatus into and out of the pot.

By allowing for air permeable containers to stack around a central stand the user can efficiently steam a large number of shrimp or food items at once.

### BRIEF DESCRIPTION OF THE SEVERAL VIEWS OF THE DRAWINGS

FIG. 1 is a perspective view, showing a prior art shrimp boiling pot.

FIG. 2 is a perspective view, showing the stand of the present invention.

FIG. 3 is a perspective view, showing an alternative embodiment of the stand of the present invention.

FIG. 4 is a perspective view, showing the air permeable container of the present invention.

FIG. 5 is a perspective view, showing the lift hook of the present invention.

FIG. 6 is a perspective view, showing the present invention being assembled.

FIG. 7 is a perspective view, showing shrimp in the air permeable container of the present invention.

FIG. 8 is a detail view, showing the air permeable container assembled with the stand of the present invention.

FIG. 9 is a detail view, showing the air permeable container assembled on the stand of the present invention.

FIG. 10 is a perspective view, showing the present invention being assembled.

FIG. 11 is a cross section view, showing the stacking of the air permeable container in the present invention.

FIG. 12 is a cross section view, showing an alternative embodiment of the present invention.

FIG. 13 is a detail view, showing the hook of the present invention.

FIG. 14 is a perspective view, showing the present invention being placed into a shrimp boiling pot.

FIG. 15 is a perspective view, showing the present invention inside of a shrimp boiling pot.

FIG. 16 is a perspective view, showing the present invention being taken out of a shrimp boiling pot.

### REFERENCE NUMERALS IN THE DRAWINGS

| | | | |
|---|---|---|---|
| 10 | shrimp pot | 12 | lid |
| 14 | hole | 16 | supporting element |
| 18 | stand | 20 | air permeable container |
| 22 | base | 24 | sidewall |
| 26 | cylindrical pipe | 28 | legs |
| 30 | lift hook | 32 | handle |
| 34 | hook | 36 | water |
| 38 | steam | 40 | shrimp |
| 42 | pole | 44 | ledge |
| 46 | air permeable container | 48 | cylindrical pipe |
| 50 | base | 52 | sidewall |
| 54 | heating element | 56 | escape port |
| 58 | bore | 60 | contact surface |
| 62 | upper extreme | | |

### DETAILED DESCRIPTION OF THE INVENTION

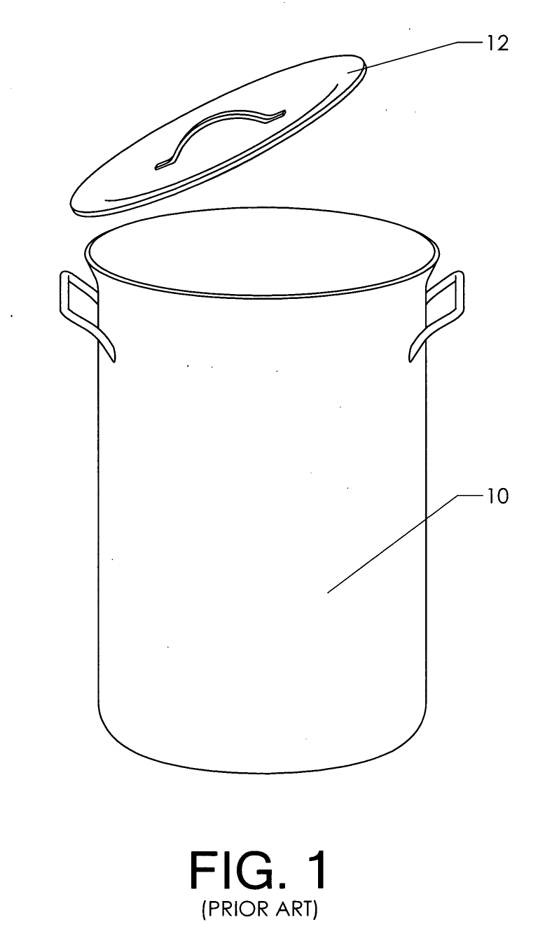

FIG. 1 shows a prior art shrimp pot 10 with lid 12. Lid 12 can be placed over shrimp pot 10 to contain steam created by boiling water. The preferred embodiment of the present invention is designed to fit into shrimp pot 10 however the reader should appreciate that the dimensions of the present invention can be modified to fit into any sized boiling pot.

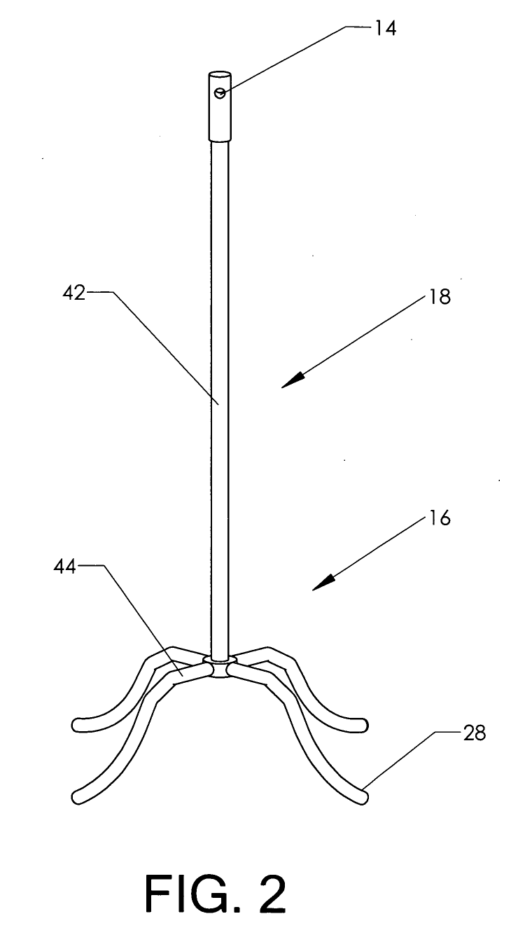

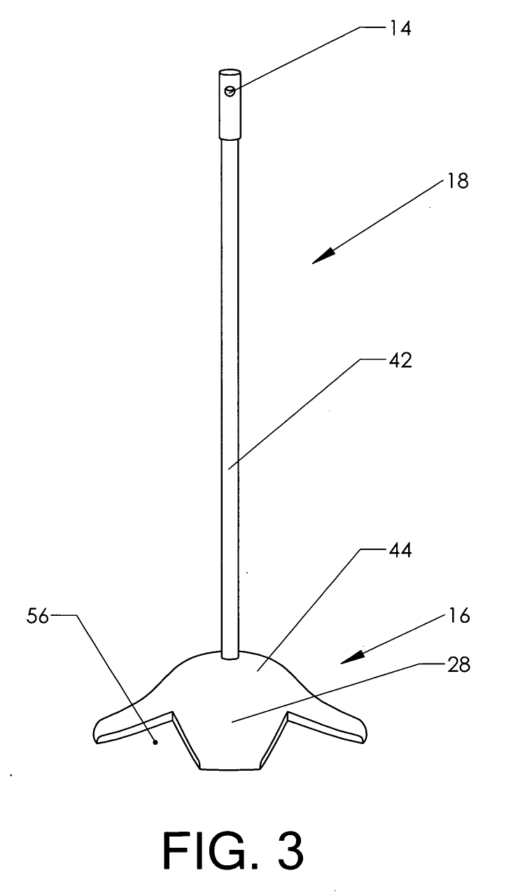

FIG. 2 through FIG. 5 show the component parts of the present invention. FIG. 2 illustrates stand 18. Stand 18 is made up of a cylindrical pole 42 and supporting element 16. In the preferred embodiment hole 14 is located at the upper extreme of cylindrical pole 42. Likewise, in the preferred embodiment supporting element 16 is made up of ledge 44 and four legs 28. However, any number of legs 28 could support stand 18 and serve the same function. For example, FIG. 3 shows that supporting element 16 can be one integrated ledge 44 and leg 28. In this embodiment large escape ports 56 must be provided for the steam formed on the base of stand 18 to escape.

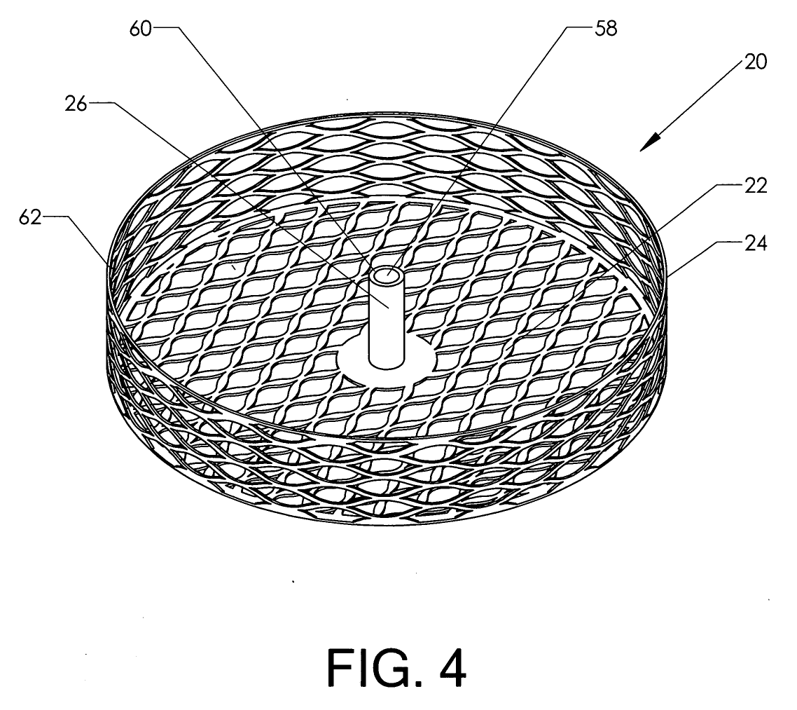

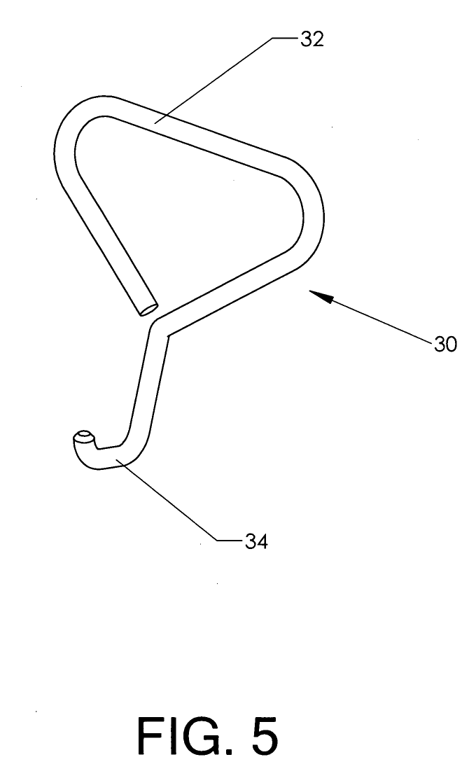

Returning to FIG. 2, ledge 44 extends away from cylindrical pole 42 in an approximately perpendicular manner then drops downward to legs 28. Legs 28 support stand 18. Air permeable container 20 is shown in FIG. 4. In the preferred embodiment air permeable container 20 has a circular base 22 with a center and a perimeter that is air permeable. Sidewall 24 surrounds the perimeter of base 22 and is also air permeable. Sidewall 24 has upper extreme 62 located on the upward facing edge of sidewall 24. Base 22 and sidewall 24 can be made of any material that is both air permeable and can withstand heat. An expanded metal such as expanded steel metal or expanded aluminum metal is preferable. A hollow cylindrical pipe 26 with a central bore 58 and an upper contact surface 60 is located in the center of base 22. FIG. 5 shows lift hook 30, another component part of the present apparatus. Lift hook 30 is comprised of handle 32 and hook 34 and is designed to fit into hole 14 of stand 18.

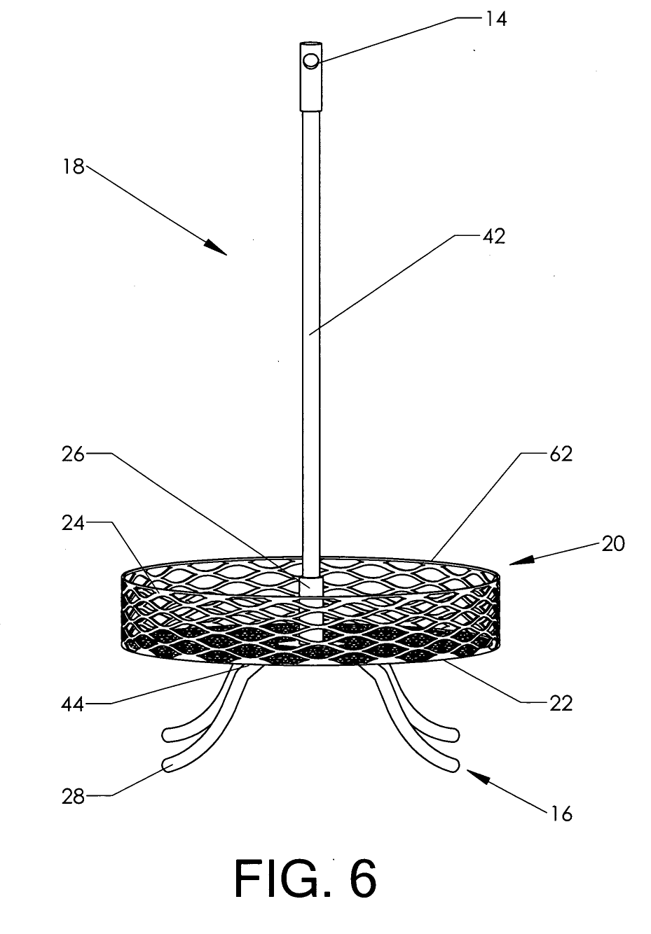

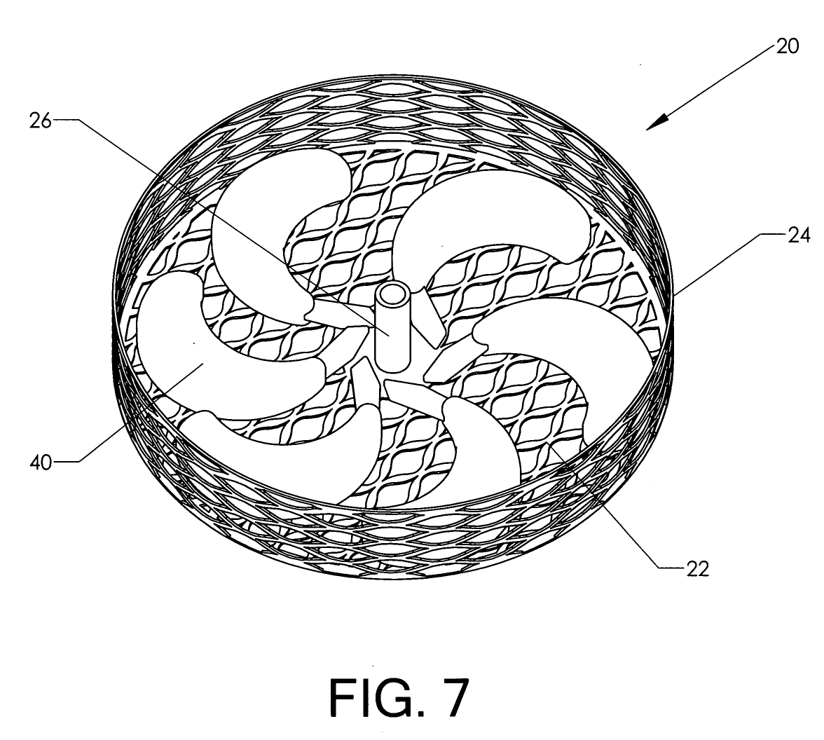

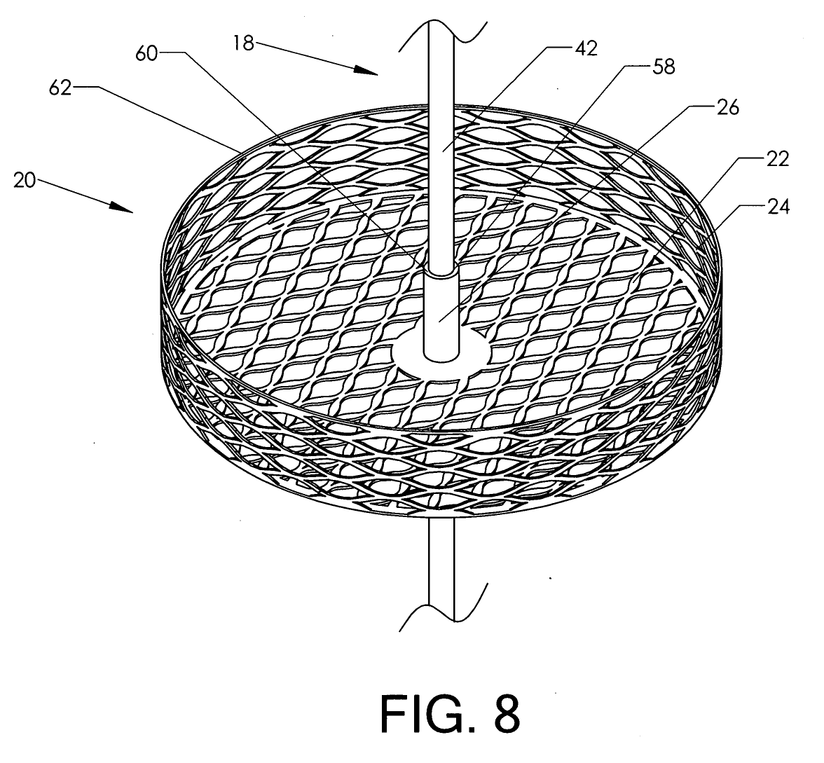

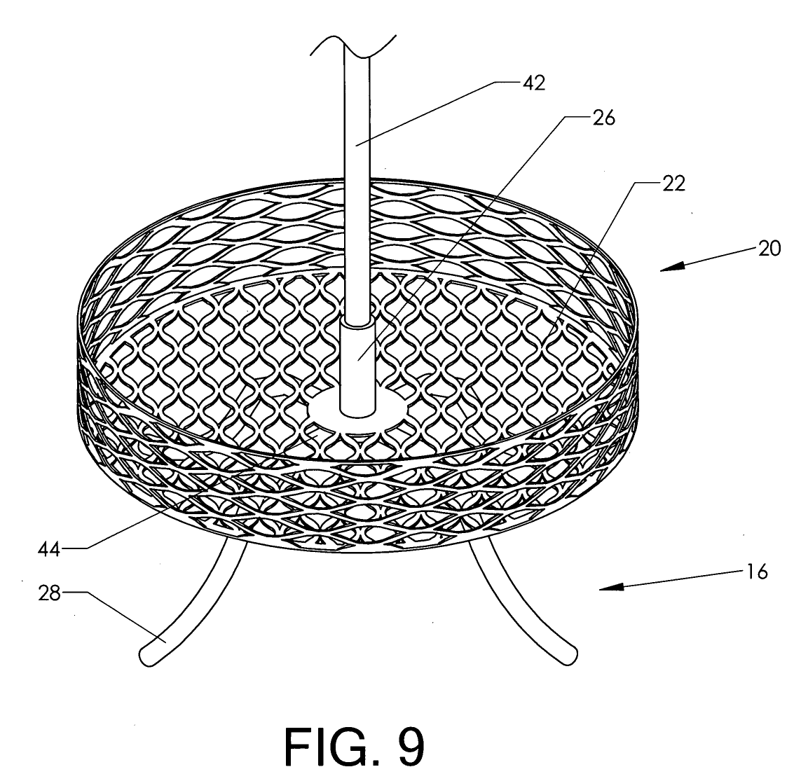

FIG. 6 illustrates the preferred embodiment of the invention in the first stage of assembly. Stand 18 is placed in an upright position supported by legs 28 of supporting element 16. Shrimp 40 is placed in air permeable container 20, as shown in FIG. 7. A shallow air permeable container 20 allows shrimp 40 to be arranged so as to maximize the exposure of the surface area of each shrimp 40. Returning to FIG. 6, stand 18 accepts air permeable container 20 by sliding cylindrical pipe 26 over pole 42. The diameter of pole 42 should be slightly smaller than the internal diameter of cylindrical pipe 26, or bore 58 (not shown), in order to provide a loose sliding fit. This ensures that pole 42 fits through cylindrical pipe 26 effectively attaching air permeable container 20 to stand 18. FIG. 8 shows a detail view of pole 42 accepting air permeable container 20 at bore 58. Pole 42 fits through cylindrical pipe 26 at bore 58 such that air permeable container 20 is able to slide down pole 42. Air permeable container 20 slides down pole 42 until it reaches supporting element 16, as shown in an exploded view in FIG. 9, where base 22 of air permeable container 20 comes to rest upon ledge 44.

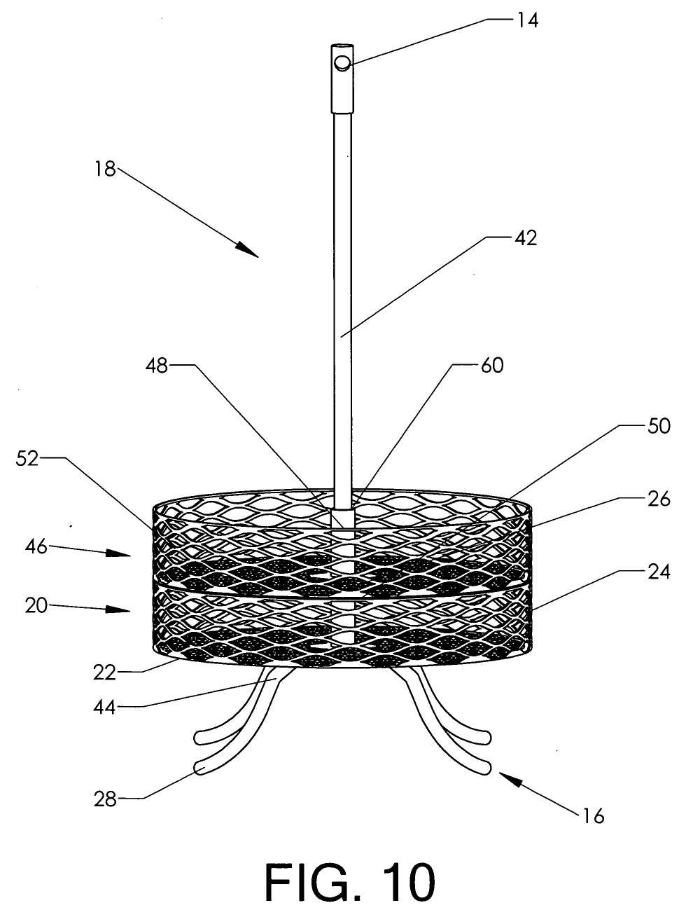

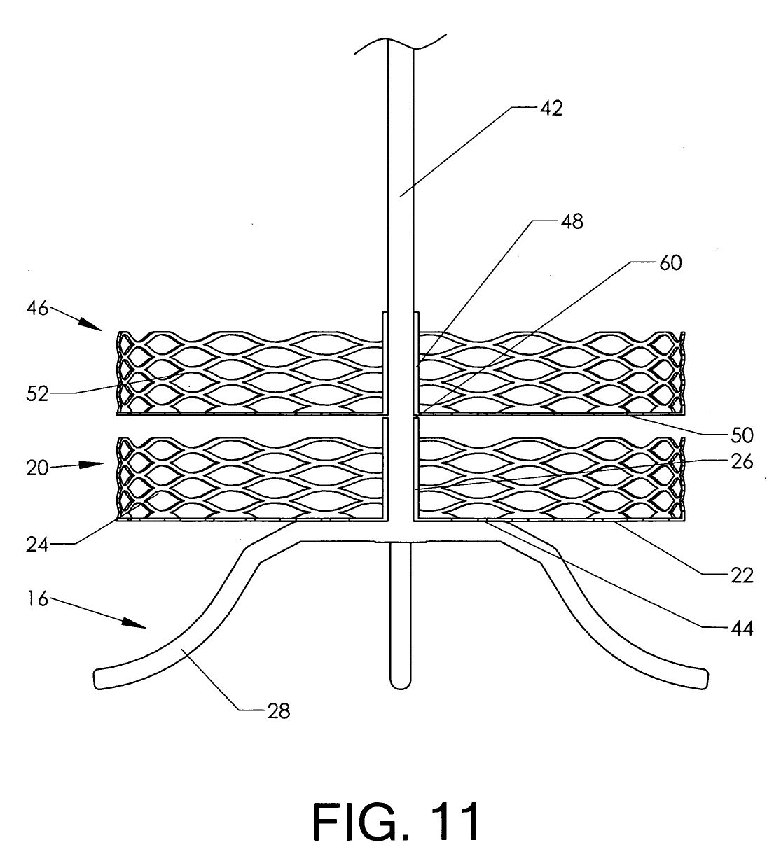

FIG. 10 and FIG. 11 illustrate the stackable nature of air permeable container 20. The illustration in FIG. 10 portrays the present invention in a second stage of assembly. Base 22 of a first air permeable container 20 rests upon ledge 44. Similar to the first air permeable container 10, a second air permeable container 46 is accepted by stand 18 at cylindrical pipe 48 and slides down pole 42. However, unlike first air permeable container 20, base 50 of second air permeable container 46 rests upon the upper contact surface 60 of cylindrical pipe 26 of first air permeable container 20. A cross sectional view of a first air permeable container 20 and a second air permeable container 46 is shown in FIG. 11.

When second air permeable container 46 slides down pole 42, base 50 of second air permeable container 46 rests upon contact surface 60 of cylindrical pipe 26 of first air permeable container 20 preventing second air permeable container 46 from progressing further down pole 42. This result could also be obtained when base of upper cylindrical pipe 48 contacts the contact surface 60 of cylindrical pipe 26 of first air permeable container 46. In the preferred embodiment cylindrical pipe 26 of first air permeable container 20 is slightly taller than the height of sidewall 24 thereby allowing second air permeable container 46 to sit slightly above sidewall 26 of first air permeable container 20. In this embodiment a lower sidewall 24 can allow better steam circulation around each shrimp, thereby cooking the shrimp faster.

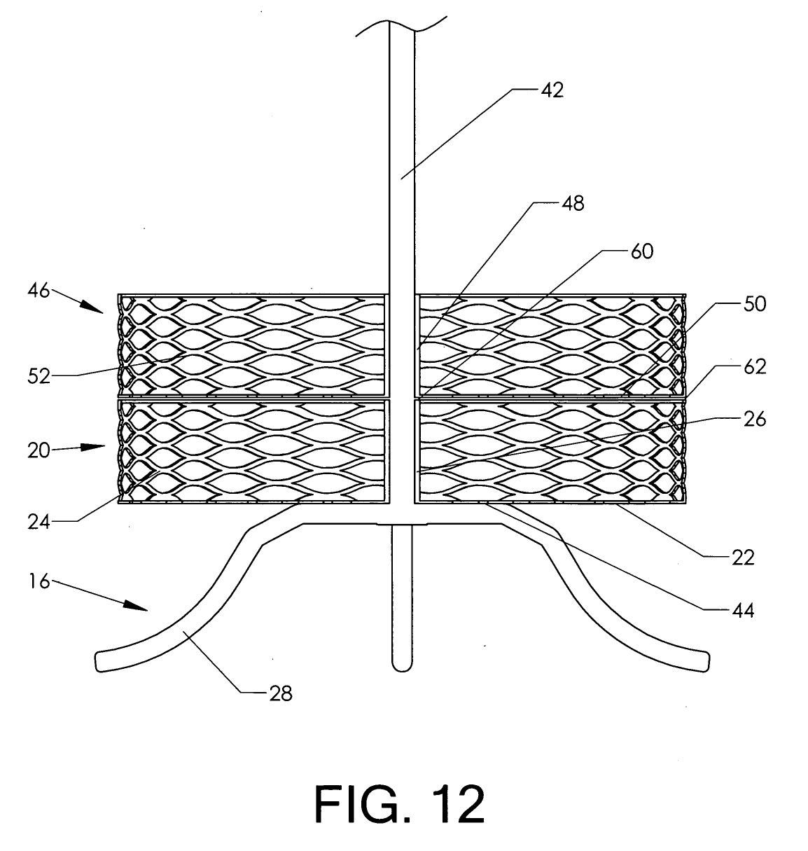

However, as shown in FIG. 12, it would also be effective for cylindrical pipe 26 to be substantially the same height as or lower than sidewall 24, allowing sidewall 52 and base 50 of second air permeable container 46 to contact upper extreme 62 of sidewall 24 of first air permeable container 20. In this alternative embodiment an enclosed pocket would be created between first air permeable container 20 and base 50 of second air permeable container 46.

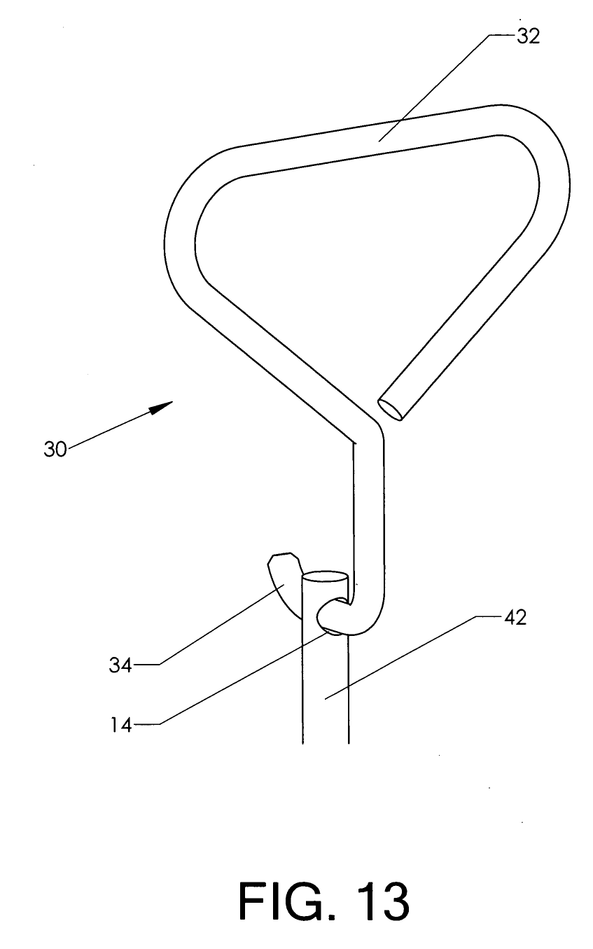

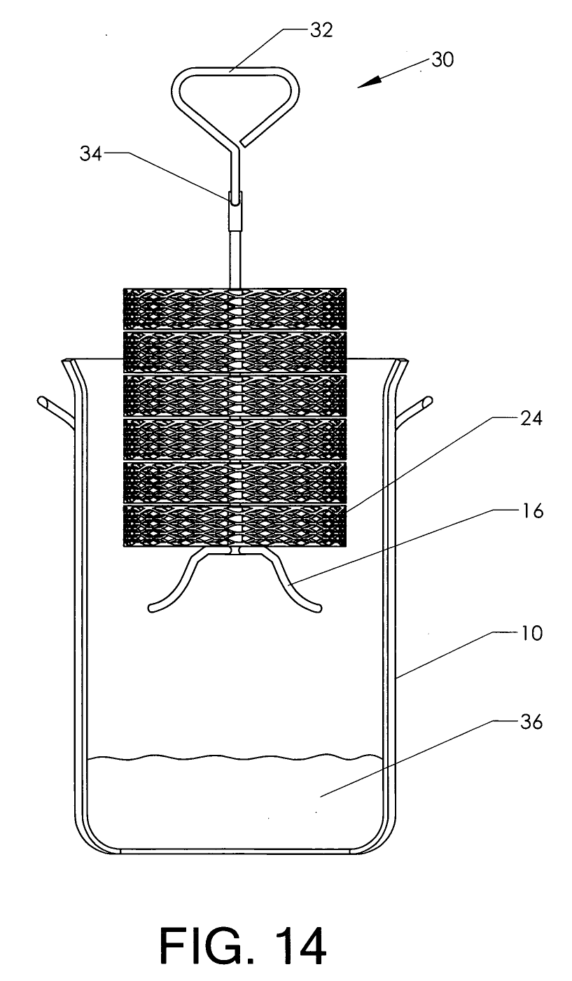

FIG. 13 illustrates a detail view of lift hook 30 showing hook 34 passing through hole 14. The user can grasp handle 32 in order to move the entire apparatus. The operation of lift hook 30 can be seen in FIG. 14 when the present invention is placed into shrimp pot 10 after being fully assembled. A volume of water 36 is added to shrimp pot 10 preferably prior to the present invention being placed into shrimp pot 10. The present invention can then be lowered into shrimp pot 10.

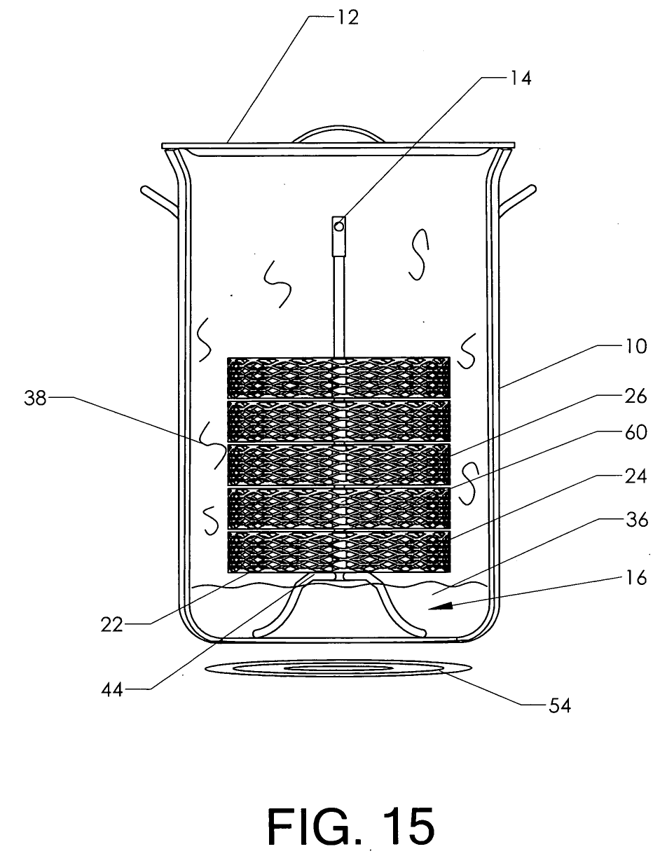

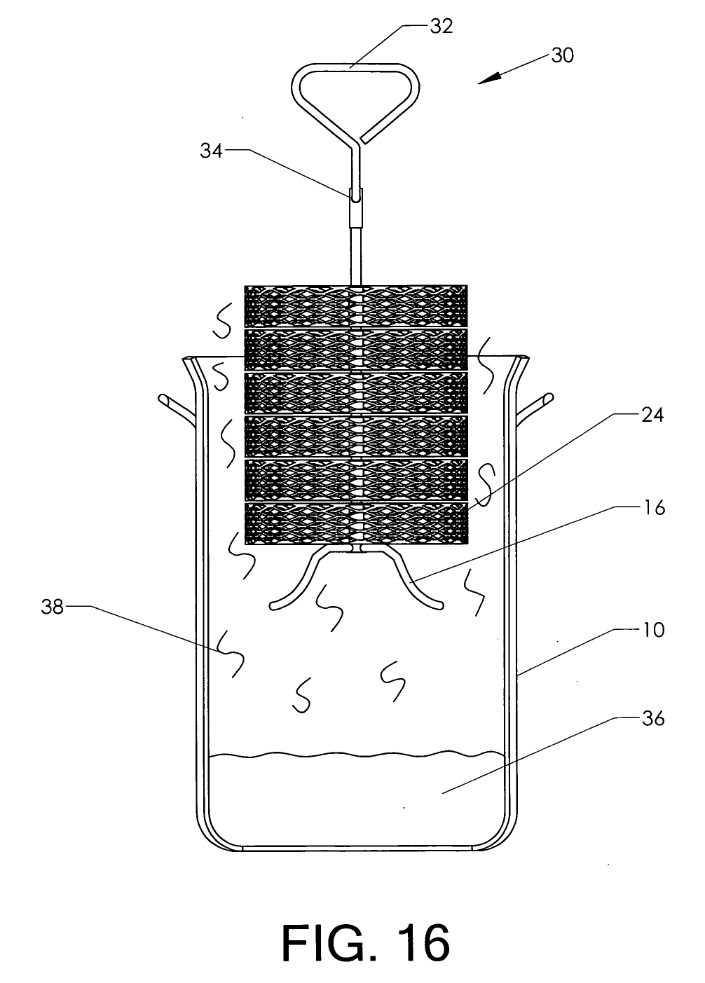

FIG. 15 illustrates the preferred embodiment of the present invention fully assembled and placed inside shrimp pot 10. The reader will observe that supporting element 16 operates to prevent air permeable container 20 from being submerged in water 36. A plurality of air permeable containers 20 are stacked on top of one another around a central stand 18. Each successive air permeable container 20 is supported by contact surface 60 of cylindrical pipe 26 of the air permeable container 20 beneath it. Shrimp pot 10 is exposed to heating element 54. The heat from heating element 54 brings water 36 to a boil, producing steam 38. Steam 38 is trapped within shrimp pot 10 by lid 12 and cooks shrimp 40 (not shown). As illustrated in FIG. 16 lift hook 30 can be used to lift the entire apparatus from shrimp pot 10 after a sufficient period of time. Lift hook 30 operates to allow the user to easily move the entire apparatus to and from the shrimp pot 10 becoming especially helpful when the apparatus is hot after steaming, such as illustrated in FIG. 16.

The preceding description contains significant detail regarding the novel aspects of the present invention. It should not be construed, however, as limiting the scope of the invention but rather as providing illustrations of the preferred embodiments of the invention. As an example, sidewall 24 of air permeable container 20 could be a different height in each successive air permeable container. Additionally, air permeable container 20 could be made in different shapes to correspond with different types of boiling pots. Thus, the scope of the invention should be fixed by the following claims, rather than by the examples given.

Having described my invention, I claim:

1. An apparatus allowing a user to steam food in a pot, comprising:
a. a stand, having a lower extreme, a supporting element proximate said lower extreme, and a pole extending upward from said supporting element;
b. wherein said supporting element includes a ledge which is vertically offset from said lower extreme;
c. a first air permeable container, including
i. a base having a center and a perimeter,
ii. a sidewall extending upward from said base proximate said perimeter,
iii. a cylindrical pipe extending upward from said base proximate said center, said cylindrical pipe having an upward facing contact surface and a bore passing vertically therethrough, with said bore being sized to freely slide along said pole;
d. wherein said ledge is positioned so that when said first air permeable container is connected to said stand by sliding said bore of said cylindrical pipe of said first air permeable container down said pole, said first air permeable container will come to rest upon said ledge;
e. a second air permeable container, including
i. a base having a center and a perimeter,
ii. a sidewall extending upward from said base proximate said perimeter,
iii. a cylindrical pipe extending upward from said base proximate said center, said cylindrical pipe having an upward facing contact surface and a bore passing vertically therethrough, with said bore being sized to freely slide along said pole; and
f. wherein when said second air permeable container is connected to said stand by sliding said bore of said cylindrical pipe of said second air permeable container down said pole, said second air permeable container will come to rest upon said upward facing contact surface of said cylindrical pipe of said first air permeable container.

2. An apparatus as recited in claim 1, further comprising a plurality of air permeable container, including:
a. a base having a center and a perimeter,
b. a sidewall extending upward from said base proximate said perimeter, and
c. a cylindrical pipe extending upward from said base proximate said center, said cylindrical pipe having an upward facing contact surface and a bore passing vertically therethrough, with said bore being sized to freely slide along said pole.

3. An apparatus as recited in claim 1, said sidewall having an upper extreme, wherein said upper extreme of said sidewall is lower than said upward facing contact surface of said cylindrical pipe.

4. An apparatus as recited in claim 1, wherein said pole of said stand further comprises a hole.

5. An apparatus as recited in claim 4, further comprising a hook, wherein said hook is configured to fit into said hole.

6. An apparatus as recited in claim 1, wherein said base and said sidewall of said first and second air permeable container are comprised of an expanded metal.

7. An apparatus allowing a user to steam food in a pot, comprising:
a. a stand, having a lower extreme, a supporting element proximate said lower extreme, and a pole extending upward from said supporting element;
b. wherein said supporting element includes a ledge which is vertically offset from said lower extreme;
c. a first air permeable container, including
i. a base having a center and a perimeter,
ii. a sidewall extending upward from said base proximate said perimeter, said sidewall having an upper extreme,
iii. a cylindrical pipe extending upward from said base proximate said center, said cylindrical pipe having a bore passing vertically therethrough, with said bore being sized to freely slide along said pole;
d. wherein said ledge is positioned so that when said first air permeable container is connected to said stand by sliding said bore of said cylindrical pipe of said first air permeable container down said pole, said first air permeable container will come to rest upon said ledge;
e. a second air permeable container, including
i. a base having a center and a perimeter,
ii. a sidewall extending upward from said base proximate said perimeter, said sidewall having an upper extreme,
iii. a cylindrical pipe extending upward from said base proximate said center, said cylindrical pipe having a bore passing vertically therethrough, with said bore being sized to freely slide along said pole; and
f. wherein when said second air permeable container is connected to said stand by sliding said bore of said cylindrical pipe of said second air permeable container down said pole, said second air permeable container will come to rest upon said upper extreme of said sidewall of said first air permeable container.

8. An apparatus as recited in claim 7, further comprising a plurality of air permeable container, including:
a. a base having a center and a perimeter,
b. a sidewall extending upward from said base proximate said perimeter, and
c. a cylindrical pipe extending upward from said base proximate said center, said cylindrical pipe having an upward facing contact surface and a bore passing vertically therethrough, with said bore being sized to freely slide along said pole.

9. An apparatus as recited in claim 7, wherein said upper extreme of said sidewall is approximately the same height as said upward facing contact surface of said cylindrical pipe.

10. An apparatus as recited in claim 7, wherein said pole of said stand further comprises a hole.

11. An apparatus as recited in claim 10, further comprising a hook, wherein said hook is configured to fit into said hole.

12. An apparatus as recited in claim 7, wherein said base and said sidewall of said first and second air permeable container are comprised of an expanded metal.

13. An apparatus allowing a user to steam food in a pot, comprising:
a. a stand, having a lower extreme, a supporting element proximate said lower extreme, and a pole extending upward from said supporting element;
b. wherein said supporting element includes a ledge which is vertically offset from said lower extreme and a plurality of legs which extend downward away from said ledge in an approximately perpendicular direction;
c. a first air permeable container, including
i. a base having a center and a perimeter,
ii. a sidewall extending upward from said base proximate said perimeter,
iii. a cylindrical pipe extending upward from said base proximate said center, said cylindrical pipe having an upward facing contact surface and a bore passing vertically therethrough, with said bore being sized to freely slide along said pole;
d. wherein said ledge is positioned so that when said first air permeable container is connected to said stand by sliding said bore of said cylindrical pipe of said first air permeable container down said pole, said first air permeable container will come to rest upon said ledge;
e. a second air permeable container, including
i. a base having a center and a perimeter,
ii. a sidewall extending upward from said base proximate said perimeter,
iii. a cylindrical pipe extending upward from said base proximate said center, said cylindrical pipe having an upward facing contact surface and a bore passing vertically therethrough, with said bore being sized to freely slide along said pole; and
f. wherein when said second air permeable container is connected to said stand by sliding said bore of said cylindrical pipe of said second air permeable container down said pole, said second air permeable container will come to rest upon said upward facing contact surface of said cylindrical pipe of said first air permeable container.

14. An apparatus as recited in claim 13, further comprising a plurality of air permeable container, including:
a. a base having a center and a perimeter,
b. a sidewall extending upward from said base proximate said perimeter, and
c. a cylindrical pipe extending upward from said base proximate said center, said cylindrical pipe having an upward facing contact surface and a bore passing vertically therethrough, with said bore being sized to freely slide along said pole.

15. An apparatus as recited in claim 13, wherein said pole of said stand further comprises a hole.

16. An apparatus as recited in claim 15, further comprising a hook, wherein said hook is configured to fit into said hole.

17. An apparatus as recited in claim 13, wherein said base and said sidewall of said first and second air permeable container are comprised of an expanded metal.

18. An apparatus as recited in claim 13, wherein said supporting element further comprises an escape port proximate said plurality of legs.
